(19) United States
(12) Patent Application Publication
(10) Pub. No.: US 2024/0352994 A1
(43) Pub. Date: Oct. 24, 2024

(54) METHOD FOR PRODUCING VARIOUS VARIANTS OF A SERIES OF AN ELECTRICALLY OPERABLE ACTUATION SYSTEM, FULLY ELECTRICALLY OPERABLE OR HYBRID-OPERABLE DRIVE TRAIN OF A MOTOR VEHICLE, AND CONFIGURATION SYSTEM FOR PRODUCING VARIOUS VARIANTS OF A SERIES OF AN ELECTRICALLY OPERABLE ACTUATION SYSTEM

(71) Applicant: Schaeffler Technologies AG & Co. KG, Herzogenaurach (DE)

(72) Inventor: Jochen Loeffelmann, Eggolsheim (DE)

(73) Assignee: Schaeffler Technologies AG & Co. KG, Herzogenaurach (DE)

(21) Appl. No.: 18/684,880

(22) PCT Filed: Aug. 1, 2022
(86) PCT No.: PCT/DE2022/100548

§ 371 Date: Feb. 20, 2024

(30) Foreign Application Priority Data
Aug. 23, 2021 (DE) 10 2021 121 741.5

(51) Int. Cl. F16H 25/20; B60T 13/74; F16D 48/00; F16D 131/02

(52) U.S. Cl. CPC F16H 25/2015; B60T 13/746; F16D 48/00; F16D 2131/02

(57) ABSTRACT

The disclosure relates to a method for producing various variants of a series of an electrically operable actuation system for actuating components which can be connected into and/or disconnected from a drive train of a motor vehicle. The actuation system comprises a drive unit, a transmission unit, and a control unit. The actuation system is assembled from a modular kit including the following components: a first group of first drive units, at least a second group of second drive units, a first group of first transmission units, at least a second group of second transmission units, a first group of first control units, and a second group of second control units. The groups of the drive units, the groups of the transmission units and/or the groups of the control units can be mechanically and electrically coupled to each other.

### CROSS-REFERENCE TO RELATED APPLICATIONS

This application is the U.S. National Phase of PCT Application No. PCT/DE2022/100548 filed on Aug. 1, 2022, which claims priority to DE 10 2021 121 741.5 filed on Aug. 23, 2021, the entire disclosures of which are incorporated by reference herein.

### TECHNICAL FIELD

The present disclosure relates to a method for producing various variants of a series of an electrically operable actuation system for actuating components which can be connected into and/or disconnected from a drive train of a motor vehicle, wherein the actuation system comprises a drive unit, a transmission unit and a control unit. The disclosure further relates to a fully electric or hybrid drive train of a motor vehicle and a configuration system for producing various variants of a series of an electrically operable actuation system.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 113, May 2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between climbing ability, acceleration and energy consumption due to the shiftable 2-speed planetary gear set. Such drive units are also referred to as e-axles or electrically operable drive trains.

In order to prevent such electrically powered motor vehicles from rolling away unintentionally, e.g., on a slope, these vehicles can have a vehicle parking lock device, which ensures a form-fitting locking of the driven vehicle wheels within the vehicle drive train and thus prevents the motor vehicle from rolling away. In this way, a function similar to a handbrake is implemented in the vehicle, wherein a handbrake is usually intended to prevent a force-fitting blocking of the driven vehicle wheels; in the case of a vehicle parking lock device, this is achieved by a form-fitting locking mechanism within the vehicle drive train.

Particularly in vehicles with electric drives, vehicle parking lock devices are used to prevent the vehicle from unintentionally rolling away in the event of the vehicle coming to a standstill or when the engine is switched off or not supplied with power. For this purpose, the vehicle parking lock devices can be activated mechanically, electrically and/or hydraulically or fully automatically by the vehicle control system by the driver using a parking lock operating device.

The vehicle parking lock device then typically blocks a shaft within the power flow in a vehicle drive train, for example within a differential axle transmission. The shaft to be blocked is selected such that its blocking reliably prevents movement of the drive wheels of the motor vehicle.

Various clutch and actuator concepts in conjunction with a corresponding electronic control of an electrically operable drive train are known for actuating a vehicle parking lock device and for actuating the shiftable planetary gear set. Such architectures have so far been comparatively complex and expensive due to the number of actuators and couplings used.

### SUMMARY

It is therefore the object of the disclosure to provide a method for producing various variants of a series of an electrically operable actuation system for actuating components which can be connected into and/or disconnected from a drive train of a motor vehicle, which enables provision of different actuation systems in a cost-optimized manner.

This object is achieved by a method for producing various variants of a series of an electrically operable actuation system for actuating components which can be connected into and/or disconnected from a drive train of a motor vehicle, wherein the actuation system comprises a drive unit, a transmission unit, and a control unit, wherein the actuation system is assembled from a modular kit having the following components:
a first group of first drive units and at least one second group of second drive units,
a first group of first transmission units and at least one second group of second transmission units, and
a first group of first control units and a second group of second control units, and
   wherein the groups of the drive units, the groups of the transmission units and/or the groups of the control units can be mechanically and electrically coupled to one another, wherein the method has the following steps:
removing a drive unit from one of the groups of drive units,
removing a transmission unit from one of the groups of transmission units,
removing a control unit from one of the groups of control units, and.
mechanically and electrically coupling the removed drive unit, transmission unit, and control unit to form a structural unit of a variant of the series of the electrically operable actuation system.

This makes it possible to provide a modular actuation system that can be used for a variety of applications within a drive train of a motor vehicle. This modular approach to producing an actuation system makes it possible to adapt actuation systems to customer specifications, wherein the smallest possible number of components of the actuation system that can be produced as simply and cost-effectively as possible allow a maximum number of possible variations.

The actuation systems produced using the method according to the disclosure can be used in an electric axle drive train of a motor vehicle. An electric axle drive train of a motor vehicle comprises an electric machine and a transmission arrangement, wherein the electric machine and the transmission arrangement form a structural unit.

Provision can in particular be made for the electric machine and the transmission arrangement to be arranged in a common drive train housing. Alternatively, it would of course also be possible for the electric machine to have a motor housing and the transmission to have a transmission housing, wherein the structural unit can then be brought about by fixing the transmission arrangement in relation to the electric machine. This structural unit is sometimes also referred to as an e-axle.

In the context of the disclosure, the electric machine can be configured as a radial or axial flux machine. To form an axially particularly compact axle drive train, preference should be given to axial flux machines.

The electric machine is intended in particular for use within an electrically operable drive train of a motor vehicle. In particular, the electric machine is dimensioned such that vehicle speeds of more than 50 km/h, preferably more than 80 km/h and in particular more than 100 km/h can be achieved. The electric motor particularly preferably has an output of more than 30 KW, preferably more than 50 KW and in particular more than 70 KW. Furthermore, it is preferred that the electric machine provides speeds greater than 5,000 rpm, particularly preferably greater than 10,000 rpm, very particularly preferably greater than 12,500 rpm.

The transmission arrangement of the electric axle drive train can, in particular, be coupled to the electric machine, which is designed to generate a drive torque for the motor vehicle. The drive torque can be a main drive torque, such that the motor vehicle is driven exclusively by the drive torque. Additionally, the transmission arrangement can comprise a multi-speed, shiftable transmission stage.

In an example embodiment, the multi-speed shiftable transmission stage is actuated by means of an actuation system, as is provided by means of the method according to the disclosure. In a further example embodiment, the transmission arrangement has a parking lock which can engage in the transmission arrangement or be decoupled therefrom, wherein the parking lock is actuated by means of an actuation system, as is provided by means of the method according to the disclosure.

A control unit, as used in the present disclosure, is used in particular in open and/or closed-loop electronic control of one or more electrical systems of an actuation system. For example, the control unit can be used to control/regulate an electric motor or solenoid of a drive unit of the actuation system.

A control unit has, in particular, a wired or wireless signal input for receiving in particular electrical signals, such as sensor signals, for example. Furthermore, a control unit likewise can have a wired or wireless signal output for the transmission of, in particular, electrical signals, for example to electrical actuators or electrical consumers of a motor vehicle.

Open-loop control operations and/or closed-loop control operations can be carried out within the control unit. In an example embodiment, the control unit comprises hardware that is designed to run software. The control unit can comprise at least one electronic processor for executing program sequences defined in software.

The control unit can also have one or more electronic memories in which the data contained in the signals transmitted to the control unit can be stored and read out again. Furthermore, the control unit can have one or more electronic memories in which data can be stored in a modifiable and/or non-modifiable manner.

A control unit can comprise a plurality of control devices which are arranged in particular spatially separate from one another in the motor vehicle. Control devices are also referred to as electronic control units (ECU) or electronic control modules (ECM) and can have electronic microcontrollers for carrying out computing operations for processing data, typically using software. The control devices can be networked with one another such that wired and/or wireless data exchange between control devices is made possible. In particular, it is also possible to network the control devices with one another via bus systems present in the motor vehicle, such as a CAN bus or LIN bus for example.

According to an example embodiment of the disclosure, it can be provided that a drive unit is selected from the group of electric rotary motors, electric linear motors and/or solenoids.

According to a further example embodiment of the disclosure, it can also be provided that a transmission unit can be designed in particular to convert a rotary movement into a linear movement and/or vice versa, in particular in the form of a spindle drive.

Furthermore, according to an example embodiment of the disclosure, it can be provided that the transmission unit designed as a spindle drive has a rotatable spindle which can be coupled to the drive unit and which meshes with a rotationally fixed but translationally displaceable spindle nut.

According to a further example embodiment of the disclosure, it can be provided that the spindle nut has a sensor target for determining the position of the spindle nut, which can be detected by a sensor arranged in the transmission unit, wherein a sensor signal from the sensor representing the position of the spindle nut is sent to the control unit.

Furthermore, the disclosure can also be further developed in such a way that the spindle nut can be displaced in at least one translational direction against the action of at least one spring element. The advantage of this configuration is that the spindle nut meshes with the spindle without play and can also be pushed back into a starting position by the spring, for example in the event of a power failure in the drive unit, so that the actuation system can then be transferred to a predefined operating position.

In an example embodiment of the disclosure, it can also be provided that the actuation system is configured for actuating a parking lock and/or a clutch device. In this way it can be achieved that two different assemblies in a drive train of a motor vehicle can each be actuated with an actuation system, wherein these actuation systems are produced using an identical method.

It can also be advantageous to further develop the disclosure in such a way that the coupling of one of the drive units, transmission unit and control units to form a structural unit takes place in a form-fitting and/or force-fitting manner. In particular, the coupling can be implemented using plug connections, snap connections, snap-lock connections or the like.

The object of the disclosure is further achieved by a fully electric or hybrid drive train of a motor vehicle, comprising at least one parking lock and at least one clutch device, wherein the parking lock and the clutch device are produced according to the method described herein. This can ensure that the drive train can be designed to be particularly cost-effective.

Finally, the object of the disclosure can also be achieved by a configuration system for producing various variants of a series of an electrically operable actuation system for actuating components which can be connected into and/or disconnected from a drive train of a motor vehicle, wherein the actuation system comprises a drive unit, a transmission unit and a control unit, wherein the configuration system comprises a server with a memory for storing configuration data of various variants of a series of actuation systems, and the actuation system is assembled from a modular kit having the following components:
a first group of first drive units and at least one second group of second drive units,
a first group of first transmission units and at least one second group of second transmission units, and
a first group of first control units and a second group of second control units, and
wherein the groups of the drive units, the groups of the transmission units and/or the groups of the control units can be mechanically and electrically coupled to one another, and
wherein the configuration system allows a selection of the desired components from the modular kit, and carries out a calculation of constructive data of the actuation system consisting of the selected components, wherein the configuration system generates control commands for the at least partially automated production of the actuation system based on the selection of components from the modular kit.

### BRIEF DESCRIPTION OF THE DRAWINGS

The disclosure will be explained in more detail below with reference to figures without limiting the general concept of the disclosure.

In the figures:

FIG. 1 shows a modular kit for producing various variants of a series of an electrically operable actuation system for actuating components which can be connected into and/or disconnected from a drive train of a motor vehicle,

FIG. 2 shows a drive train of a motor vehicle with components that can be connected into and/or disconnected therefrom, with various variants of a series of an electrically operable actuation system, and

FIG. 3 shows a configuration system for producing various variants of a series of an electrically operable actuation system for actuating components that can be connected into and/or disconnected from a drive train of a motor vehicle.

### DETAILED DESCRIPTION

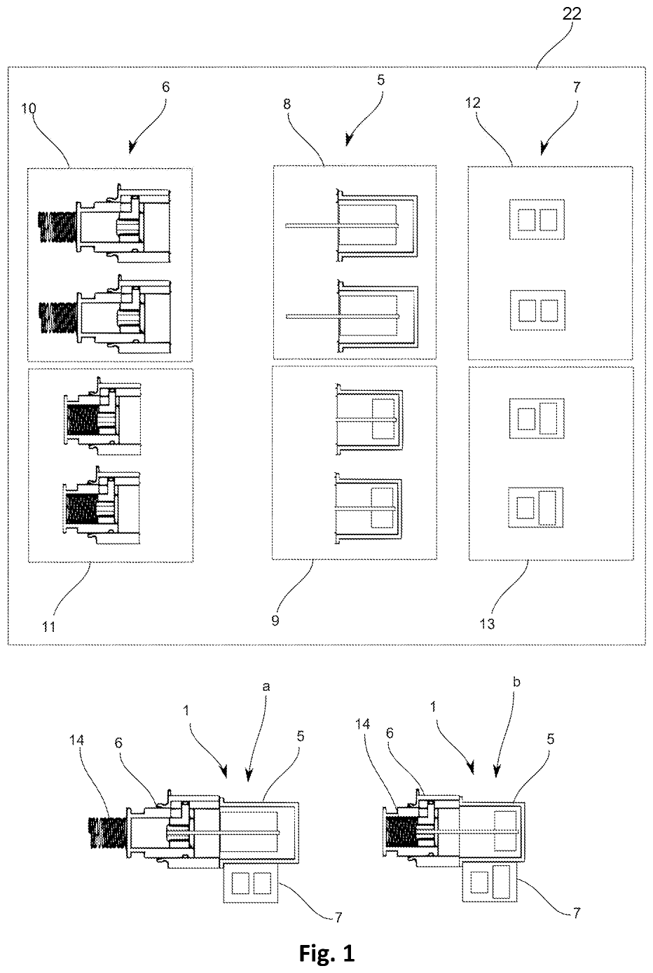

Based on FIG. 1, a method for producing various variants of a series of an electrically operable actuation system 1 for actuating components 4 that can be connected into and/or disconnected from a drive train 2 of a motor vehicle 3 is first explained in more detail.

Each variant of the actuation system 1 initially comprises a drive unit 5, a transmission unit 6 and a control unit 7. As outlined in FIG. 1, the actuation system 1 is assembled from a modular kit 22, which has the following components:

A first group 8 of first drive units 5 and at least one second group 9 of second drive units 5; a first group 10 of first transmission units 6 and at least one second group 11 of second transmission units 6; and a first group 12 of first control units 7 and a second group 13 of second control units 7.

The first group 8 of first drive units 5 has, for example, a powerful motor, while the second group 9 of second drive units 5 has a relatively weaker motor, which is indicated by the size of the motors in FIG. 1.

The first group 10 of first transmission units 6 has a spring element 14 which rests on the outside of a piston connected to the spindle nut 29, while the second group 11 of second transmission units 6 has a spring element 14 arranged in the piston. The figure also shows that the spindle nut 29 can be displaced in at least one translational direction against the action of at least one spring element 14.

The first group 12 of first control units 7 has, for example, a smaller memory while the second group 13 of second control units 7 has a larger memory, which is indicated by the size of the rectangle symbolizing the memory.

The groups 8, 9 of the drive units 5, the groups 10, 11 of the transmission units 6 and/or the groups 12, 13 of the control units 12 can be mechanically and electrically coupled to one another, i.e., they are correspondingly compatible with one another. From the modular kit 22, for example, the differently configured actuation systems 1 shown in the lower part of FIG. 1, which are designated there by “a” and “b”, can be implemented.

For example, the actuation system 1 designated “a” can be configured to actuate a parking lock 15 and the actuation system 1 designated “b” can be configured to actuate a clutch device 16.

To produce a variant of the series of actuation system 1, a drive unit 5 is first removed from one of the groups 8, 9 of drive units 5, a transmission unit 6 is removed from one of the groups 10, 11 of transmission units 6 and a control unit 7 is removed from one of groups 12, 13 of control units 7.

Subsequently, the mechanical and electrical coupling of the removed drive unit 5, transmission unit 6 and control unit 7 is then carried out to form a structural unit of a variant of the series of the electrically operable actuation system 1. The coupling of one of the drive units 5, transmission unit 6 and control units 7 to form a structural unit takes place in a form-fitting and/or force-fitting manner. This can be done, for example, by plugging the components together, each of which has mutually compatible mechanical and/or electrical coupling means.

A drive unit 5 can, for example, be selected from the group of electric rotary motors, electric linear motors and/or solenoids. The transmission unit 6 can be designed in particular to convert a rotary movement into a linear movement and/or vice versa, in particular in the form of a spindle drive, as indicated in the figures.

The transmission unit 6, designed as a spindle drive, has a rotatable spindle 8 which can be coupled to the drive unit 5 and which meshes with a rotationally fixed but translationally displaceable spindle nut 9. The spindle nut 9 has a sensor target 11 for determining the position of the spindle nut 9, which can be detected by a sensor 12 arranged in the transmission unit 6, wherein a sensor signal 13 from the sensor 12 representing the position of the spindle nut 9 is sent to the control unit 7.

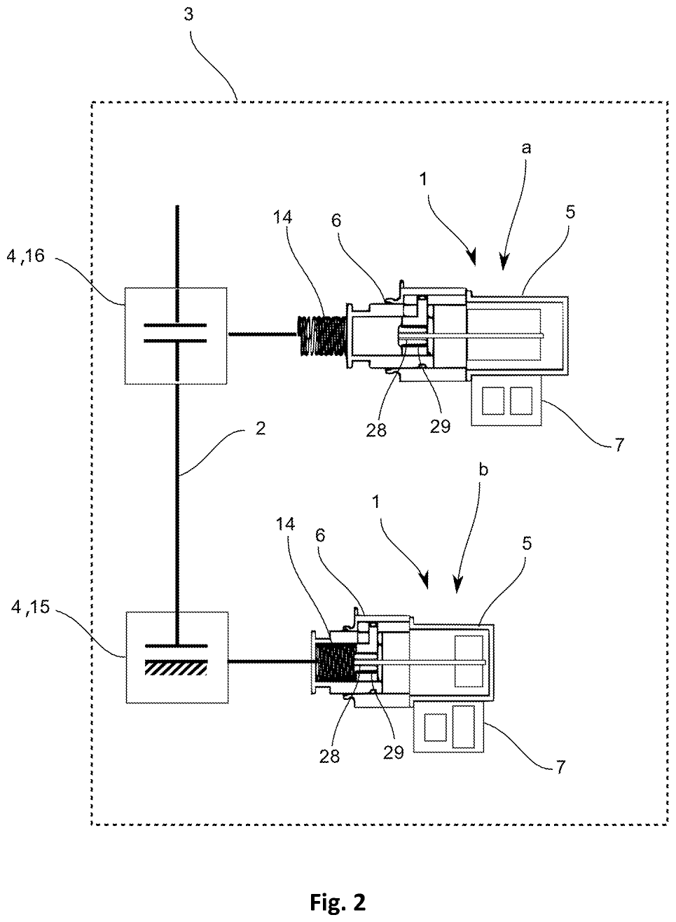

FIG. 2 shows an example application of the variants of a series of an electrically operable actuation system 1 produced using the method described. Here a fully electric or hybrid drive train 2 of a motor vehicle 3 can be seen with a parking lock 15 and a clutch device 16, wherein the parking lock 15 and the clutch device 16 are produced according to the aforementioned method. In principle, it would of course also be possible to provide further actuation systems 1 from the series in the drive train 2, for example to actuate a braking device for actuating a multi-speed, shiftable transmission.

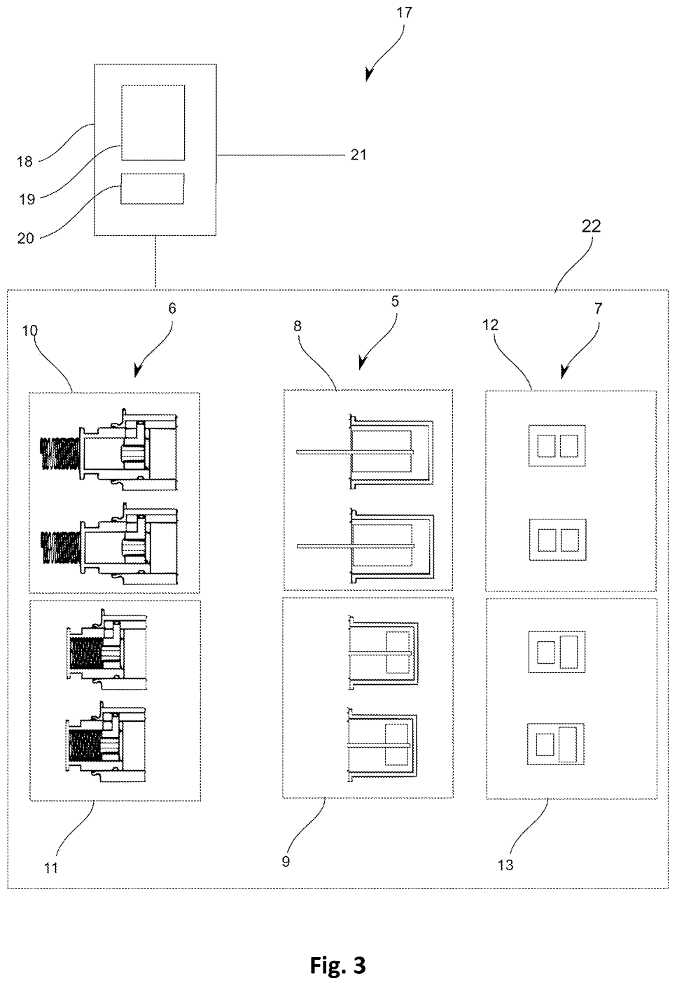

Finally, FIG. 3 shows a configuration system 17 for producing various variants of a series of an electrically operable actuation system 1 for actuating components 4 which can be connected into and/or disconnected from a drive train 2 of a motor vehicle 3, as are also shown by way of example in FIG. 2. The configuration system 17 has a server 18 with a memory for storing configuration data 19 from various variants of a series of actuation systems 1. This configuration data 19 represents the components from the modular kit 22. The configuration system 17 now allows a user to select the desired components from the modular kit 22, i.e., the configuration of various variants of a series of an actuation system 1. The selection and the corresponding configuration data 19 are then used to calculate design data 20 of the actuation system 1 consisting of the selected components, such as design dimensions and electrical parameters. Based on the selection of components from the modular kit 22, the configuration system 17 subsequently generates control commands 21 for the at least partially automated production of the actuation system 1.

The disclosure is not limited to the embodiments shown in the figures. The above description is therefore not to be regarded as limiting, but rather as illustrative.

### LIST OF REFERENCE SYMBOLS

1 Actuation system
2 Drive train
3 Motor vehicle
4 Components
5 Drive unit
6 Transmission unit
7 Control unit
8 Group
9 Group
10 Group
11 Group
12 Group
13 Group
14 Spring element
15 Parking lock
16 Clutch device
17 Configuration system
18 Server
19 Configuration data
20 Data
21 Control commands
22 Modular kit
28 Spindle
29 Spindle nut

1. A method for producing variants of an electrically operable actuation system for actuating components configured to be connected into and/or disconnected from a drive train of a motor vehicle, the electrically operable actuation system comprising a drive unit, a transmission unit, and a control unit, and the electrically operable actuation system is assembled from a modular kit comprising:
a first group of first drive units and at least one second group of second drive units,
a first group of first transmission units and at least one second group of second transmission units, and
a first group of first control units and a second group of second control units, and
any one drive unit of the groups of drive units, any one transmission unit of the groups of transmission units, and any one control unit of the groups of control units are configured to be mechanically and electrically coupled together,
the method comprising:
selectively removing a drive unit from one of: i) the first group of first drive units, or ii) the at least one second group of second drive units,
selectively removing a transmission unit from one of: i) the first group of first transmission units, or ii) the at least one second group of second transmission units,
selectively removing a control unit from one of: i) the first group of control units, or ii) the second group of second control units; and
mechanically and electrically coupling the selectively removed drive unit, the selectively removed transmission unit, and the selectively removed control unit together to form a variant of a structural unit of the electrically operable actuation system.

2. The method according to claim 1, wherein the drive unit is an electric rotary motor, an electric linear motor, or a solenoid.

3. The method according to claim 1, wherein the transmission unit is configured to convert a rotary movement into a linear movement.

4. The method according to claim 1, wherein the transmission unit is configured as a spindle drive having a rotatable spindle coupled to the drive unit and meshing with a rotationally fixed but translationally displaceable spindle nut.

5. The method according to claim 4, wherein the spindle nut has a sensor target configured for determining a position of the spindle nut, the position detected by a sensor arranged in the transmission unit, wherein and a sensor signal from the sensor corresponding to the position of the spindle nut is sent to the control unit.

6. The method according to claim 4, wherein the spindle nut is displaceable in at least one translational direction against at least one spring element.

7. The method according to claim 1, wherein the electrically operable actuation system is configured to actuate a parking lock.

8. The method according to claim 2, wherein mechanically and electrically coupling the selectively removed drive unit, the selectively removed transmission unit, and the selectively removed control unit occurs via a form-fitting or a force-fitting connection.

9. The method of claim 1, utilized to produce a parking lock and a clutch device of a fully electric or hybrid operable drive train of a motor vehicle.

10. A configuration system for producing variants of an electrically operable actuation system for actuating components which can be connected into and/or disconnected from a drive train of a motor vehicle, the configuration system comprising:
the electrically operable actuation system having a drive unit, a transmission unit, and a control unit, and
a server with a memory for storing configuration data of the variants of the electrically operable actuation system, and
the electrically operable actuation system is assembled from a modular kit comprising:
a first group of first drive units and at least one second group of second rive units,
a first group of first transmission units and at least one second group of second transmission units, and
a first group of first control units and a second group of second control units, and
any one drive unit of the groups of drive nits, any one transmission unit of the groups of transmission units, and any one control unit of the groups of control units are configured to be mechanically and electrically coupled together, and
the configuration system allows a selection of desired components from the modular kit and carries out a calculation of design data of the electrically operable actuation system comprised of the desired components, and the configuration system generates control commands for an at least partially automated production of the electrically operable actuation system based on the selection of desired components from the modular kit.

11. The method according to claim 1, wherein the transmission unit is configured to convert linear movement into a rotary movement.

12. The method according to claim 1, wherein the transmission unit is a spindle drive.

13. The method according to claim 7, wherein the electrically operable actuation system is configured to actuate a clutch device.

14. The method according to claim 1, wherein the electrically operable actuation system is configured to actuate a clutch device.

15. The method according to claim 1, wherein a power output of each one of the first group of first drive units is greater than a power output of each one of the at least one second group of second drive units.

16. The method according to claim 15, wherein a memory capacity of each one of the first group of control units is smaller than a memory capacity of each one of the second group of second control units.

17. A method for producing variants of an electrically operable actuation system for actuating components configured to be connected into and/or disconnected from a drive train of a motor vehicle, the electrically operable actuation system comprising a drive unit and a transmission unit, and the electrically operable actuation system is assembled from a modular kit comprising:
a first group of first drive units and at least one second group of second drive units, and
a first group of first transmission units and at least one second group of second transmission units, and
any one drive unit of the groups of drive units is configured to be mechanically and electrically coupled to any one transmission unit of the groups of transmission units,
the method comprising:
selectively removing a drive unit from one of: i) the first group of first drive units, or ii) the at least one second group of second drive units, and
selectively removing a transmission unit from one of: i) the first group of first transmission units, or ii) the at least one second group of second transmission units, and
mechanically and electrically coupling the selectively removed drive unit to the selective removed transmission unit to form a variant of a structural unit of the electrically operable actuation system.

18. The method of claim 17, wherein the transmission unit is configured to actuate a parking lock.

19. The method of claim 17, wherein the transmission unit is configured to actuate a clutch device.

20. The method of claim 17, wherein the drive unit is an electric rotary motor, an electric linear motor, or a solenoid.
